(19) United States
(12) Patent Application Publication
(10) Pub. No.: US 2024/0264483 A1
(43) Pub. Date: Aug. 8, 2024

(54) DISPLAY DEVICE

(71) Applicant: Japan Display Inc., Tokyo (JP)

(72) Inventors: Yoshitaka OZEKI, Tokyo (JP); Seiji UEJIMA, Tokyo (JP)

(21) Appl. No.: 18/428,652

(22) Filed: Jan. 31, 2024

(30) Foreign Application Priority Data
Feb. 8, 2023 (JP) 2023-017394

(51) Int. Cl. G02F 1/1335; G02F 1/1343

(52) U.S. Cl. CPC G02F 1/133514; G02F 1/133512; G02F 1/13439

(57) ABSTRACT

Disclosed is a display device including a substrate, a plurality of pixels located over the substrate and each including a liquid crystal element, a first overcoat over the plurality of pixels, a first light-transmitting conductive film over the first overcoat, a plurality of color filters over the first light-transmitting conductive film, and a counter substrate over the plurality of color filters. Each of the plurality of pixels may have a pixel circuit including a driving transistor electrically connected to the liquid crystal element, and the driving transistor may include an oxide semiconductor.

### CROSS-REFERENCE TO RELATED APPLICATIONS

This application claims the benefit of priority to Japanese Patent Application No. 2023-017394, filed on Feb. 8, 2023, the entire contents of which are incorporated herein by reference.

### FIELD

An embodiment of the present invention relates to a display device.

### BACKGROUND

In recent years, semiconductor properties have been discovered in oxides, especially oxides of Group 13 elements such as indium and gallium, which has led to vigorous research and development. For example, semiconductor devices on which transistors with oxide semiconductors are mounted and display devices using such devices have been developed as disclosed in Japanese Patent Application Publication No. 2013-254950.

### SUMMARY

An embodiment of the present invention is a display device. The display device includes a substrate, a plurality of pixels located over the substrate and each including a liquid crystal element, a first overcoat over the plurality of pixels, a first light-transmitting conductive film over the first overcoat, a plurality of color filters over the first light-transmitting conductive film, and a counter substrate over the plurality of color filters.

An embodiment of the present invention is a display device. The display device includes a substrate, a plurality of pixels located over the substrate and each including a liquid crystal element, an overcoat over the plurality of pixels, a plurality of color filters located over the overcoat and respectively overlapping the corresponding pixels, a light-shielding film located over the plurality of color filters and extending between adjacent pixels, at least one light-transmitting conductive film over and in contact with the light-shielding film, and a counter substrate over the at least one light-transmitting conductive film.

An embodiment of the present invention is a display device. The display device includes a substrate, a plurality of pixels located over the substrate and each including a liquid crystal element, a light-transmitting conductive film over the plurality of pixels, an overcoat over the light-transmitting conductive film, a plurality of color filters located over the overcoat and respectively overlapping the corresponding pixels, a light-shielding film located over the plurality of color filters and extending between adjacent pixels, and a counter substrate over the light-shielding film.

### BRIEF DESCRIPTION OF DRAWINGS

FIG. 1 is a schematic developed perspective view of a display device according to an embodiment of the present invention.

FIG. 2 is a schematic top view of a display device according to an embodiment of the present invention.

FIG. 3 is a schematic cross-sectional view of a display device according to an embodiment of the present invention.

FIG. 4 is a schematic cross-sectional view of a display device according to an embodiment of the present invention.

FIG. 5 is a schematic cross-sectional view of a display device according to an embodiment of the present invention.

FIG. 6 is a schematic cross-sectional view of a display device according to an embodiment of the present invention.

FIG. 7 is a schematic cross-sectional view of a display device according to an embodiment of the present invention.

FIG. 8 is a schematic cross-sectional view of a display device according to an embodiment of the present invention.

FIG. 9A is a schematic top view of a display device according to an embodiment of the present invention.

FIG. 9B is a schematic top view of a display device according to an embodiment of the present invention.

FIG. 10A is a schematic top view of a display device according to an embodiment of the present invention.

FIG. 10B is a schematic top view of a display device according to an embodiment of the present invention.

FIG. 11A is a schematic top view of a display device according to an embodiment of the present invention.

FIG. 11B is a schematic top view of a display device according to an embodiment of the present invention.

FIG. 12 is a schematic top view of a display device according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and each drawing, the same reference number is provided to an element that is the same as that which appears in preceding drawings, and a detailed explanation may be omitted as appropriate.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and the claims, an expression “a structure is exposed from another structure” means a mode in which a portion of the structure is not covered by the other structure and includes a mode where the portion uncovered by the other structure is further covered by another structure. In addition, the mode expressed by this expression includes a mode where the structure is not in contact with the other structure.

In the embodiments of the present invention, when a plurality of structures is formed with the same process at the same time, these structures have the same layer structure, the same material, and the same composition. Hence, the plurality of structures is defined as existing in the same layer.

### 1. OVERALL STRUCTURE OF DISPLAY DEVICE

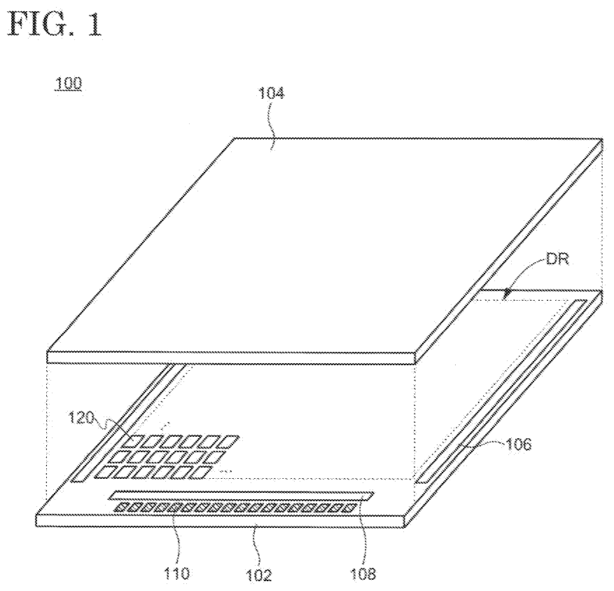

FIG. 1 shows a schematic developed perspective view of a display device 100 according to an embodiment of the present invention. The display device 100 is a liquid crystal display device and is able to function as a display device for a variety of electronic devices. For example, the display device 100 can be used as an ultra-compact display device such as virtual reality (VR) goggles, a medium or small display device used in portable communication terminals such as smartphones and tablets, a medium or large display device such as a monitor connected to a desktop computer and a television, or a large display device such as digital signage.

The display device 100 has an array substrate 102 and a counter substrate 104 between which a variety of patterned insulating films, semiconductor films, and conductive films is stacked. Appropriate combination of these insulating films, semiconductor films, and conductive films allows the formation of a variety of electrode pads, which is not illustrated, and the like in addition to pixel circuits of a plurality of pixels 120, driver circuits for controlling the pixels 120 (scanning line driver circuits 106 and signal line driver circuit 108), and a plurality of terminals 110. The region in which the plurality of pixels 120 is provided is called a display region DR, and the region surrounding the display region DR is called a frame region FR. The outer shape of the display device 100 and the shape of the display region DR are not limited to a square and may have any shape required by the electronic device on which the display device 100 is mounted, such as a polygonal shape, a polygonal shape with rounded corners, a circular shape, and an oval shape. Note that the signal line driver circuit 108 may be configured with an IC chip with a built-in signal line driver circuit, or all of or part of the signal line driver circuit 108 may be formed on the array substrate 102.

The counter substrate 104 is disposed over the array substrate 102 to cover the plurality of pixels 120 and the scanning line driver circuits 106 and expose the terminals and is fixed to the array substrate 102 with a sealing material which is not illustrated in FIG. 1. Driving signals for driving the display device 100 are supplied through a flexible printed circuit (FPC) board (not illustrated) connected to the terminals 110, and the scanning line driver circuits 106 and the signal line driver circuit generate control signals (gate signals, video signals, initialization signals, and the like) for controlling the pixels 120 on the basis of the driving signals. These control signals are supplied to the pixels 120 to operate the pixels, thereby controlling the gradation of light from the backlight, which is not illustrated, for every pixel. As a result, images can be displayed on the display region DR. Hereinafter, each component of the display device 100 is described in detail.

### 2. SUBSTRATE AND COUNTER SUBSTRATE

The array substrate 102 and the counter substrate 104 provide physical strength to the display device 100 and also provide a surface for arranging a variety of components such as the pixels 120, the scanning line driver circuits 106, the signal line driver circuit 108, and the like to realize the functions of a display device. The array substrate 102 and the counter substrate 104 are configured to transmit the light from the backlight, i.e., visible light, and include, for example, glass, quartz, or a polymer such as a polyimide, a polyamide, and a polycarbonate. The array substrate 102 and/or the counter substrate 104 may be flexible.

### 3. PIXEL

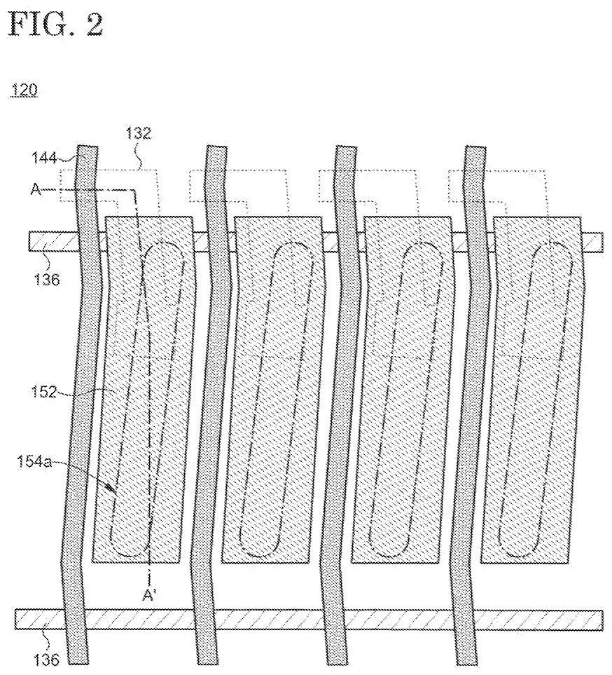

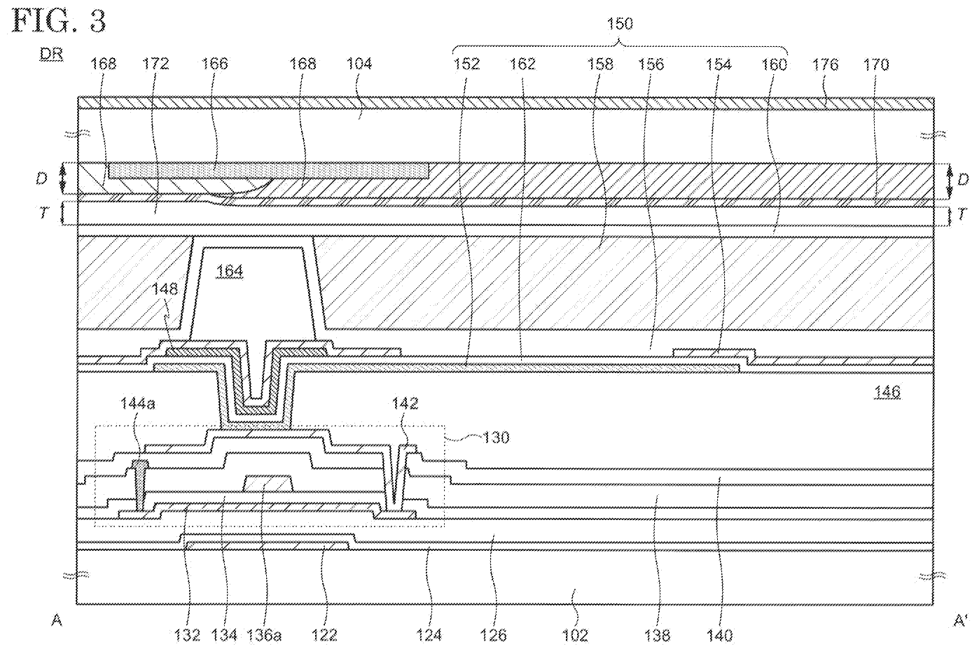

A schematic top view of the pixels 120 forming the display region DR is shown in FIG. 2, and a schematic view of a cross section along the chain line A-A′ in FIG. 2 is shown in FIG. 3. There are no restrictions on the arrangement of the pixels 120, and a variety of arrangements such as the stripe arrangement, the pen-tile arrangement, the S-stripe arrangement, the diamond pen-tile arrangement, and the like may be employed.

Each pixel 120 is provided with a liquid crystal element 150 and a pixel circuit electrically connected to the liquid crystal element 150 and controlling the liquid crystal element 150 on the basis of the control signals. The control signals are supplied via scanning lines 136 extending from the scanning line driver circuits 106 and signal lines 144 extending from the signal line driver circuit (see FIG. 2.). There is no particular restriction on the arrangement of the scanning lines 136 and the signal lines 144, and any known arrangement may be applied as appropriate. For example, a plurality of scanning lines 136 may be arranged almost parallel to one another, and a plurality of signal lines 144 each having a bending structure may be arranged to intersect the scanning lines 136 as shown in FIG. 2. Although not illustrated, the signal lines 144 having no bending structure and extending in a straight line may be arranged.

### (1) Pixel Circuit

The pixel circuit has at least one or a plurality of transistors and may further have one or a plurality of capacitance elements. FIG. 3 shows, as a component of the pixel circuit, a driving transistor 130 electrically connected to the liquid crystal element 150 and supplying a potential corresponding to the video signal to the liquid crystal element 150. Unlike the circuit transistor 180 structuring the scanning line driver circuits 106 described below, the driving transistor 130 has a semiconductor film 132 including an oxide semiconductor. Specifically, the driving transistor 130 includes: a semiconductor film 132; a gate electrode 136a overlapping the semiconductor film 132 and forming the scanning line 136; a gate insulating film 134 arranged between the semiconductor film 132 and the gate electrode 136a; a second interlayer insulating film 138 and a third interlayer insulating film 140 covering the semiconductor film 132 and the gate electrode 136a; a drain electrode 142 electrically connected to the semiconductor film 132 through a through hole passing through the third interlayer insulating film 140 to the gate insulating film 134; and a source electrode 144a electrically connected to the semiconductor film 132 through a through hole passing through the second interlayer insulating film 138 and the gate insulating film 134. The source electrode 144a also serves as the signal line 144. The driving transistor 130 shown in FIG. 3 is a so-called top-gate type transistor, but the driving transistor 130 may also be a bottom-gate type transistor and may have gate electrodes both over and under the semiconductor film 132. When a plurality of transistors is provided in each pixel circuit, the semiconductor films of the transistors other than the driving transistor 130 may contain an oxide semiconductor or silicon.

As an optional component, the display device 100 may also have a light-shielding film 122 under each pixel circuit. The light-shielding film 122 in this embodiment is provided over the array substrate 102 and overlaps the driving transistor 130. The light from the backlight (not illustrated) provided under the array substrate can be prevented from entering the driving transistor 130 by arranging the light-shielding film 122. As a result, characteristic changes and degradation of the driving transistor 130 caused by the light can be prevented. The light-shielding film 122 may be formed as a single film or a multi-layer film containing, for example, a metal such as molybdenum, chromium, nickel, hafnium, tungsten, titanium, copper, and aluminum or an alloy thereof.

The oxide semiconductor structuring the semiconductor film 132 may be selected from oxides of Group 13 elements such as indium and gallium. The oxide semiconductor may contain a plurality of different Group 13 elements, and indium-gallium oxide (IGO) is represented as an example. The oxide semiconductor may further contain a Group 12 element. A typical oxide semiconductor containing a Group 12 elment is represented by indium-gallium-zinc oxide (IGZO). The semiconductor film 132 may also contain other elements and may include a Group 14 element such as tin and a Group 4 element such as titanium and zirconium.

The scanning lines 136, the signal lines 144, and the drain electrode 142 are also configured to include a metal such as molybdenum, chromium, tungsten, titanium, copper, aluminum, hafnium, and nickel or an alloy thereof, for example.

The scanning lines 136 and the signal lines 144 may be composed of a single-layer or multi-layer film of the metal layers of these alloys or a simple substance. Each of the gate insulating film 134, the second interlayer insulating film 138, and the third interlayer insulating film 140 may be configured as a single film or a multilayer film containing an inorganic compound. As an inorganic compound, a silicon-containing inorganic compound such as silicon nitride, silicon oxide, silicon oxynitride, and silicon nitride oxide is represented. Alternatively, an aluminum-containing inorganic compound such as aluminum oxide, aluminum oxy nitride, and aluminum nitride may be used as the inorganic compound.

A planarization film 146 containing a polymer such as an acrylic resin, an epoxy resin, a polyimide resin, a polyamide resin, and a silicone resin is provided over the drain electrode 142 and the third interlayer insulating film 140. The planarization film 146 is capable of mitigating the unevenness caused by the pixel circuits and providing a relatively flat top surface, allowing the formation of the liquid crystal element 150 over a flat surface.

### (2) Liquid Crystal Element

The liquid crystal element 150 is a transmissive liquid crystal element and includes, as its basic components, a pixel electrode 152, an interelectrode insulating film 162 over the pixel electrode 152, a common electrode 154 over the interelectrode insulating film 162, a first orientation film over the common electrode 154, a liquid crystal layer 158 over the first orientation film 158, a second orientation film 160 over the liquid crystal layer 158, and a spacer 164 to maintain the thickness of the liquid crystal layer 158 as shown in FIG. 3. As can be understood from FIG. 3, the liquid crystal element 150 is a so-called FFS (Fringe Field Switching) liquid crystal device, in which the orientation of the homogeneously oriented liquid crystal molecules in the liquid crystal layer 158 is changed by applying an electric field in the horizontal direction, and the gradation is controlled according to the degree of change in the orientation of the liquid crystal molecules.

The pixel electrode 152 is electrically connected to the drain electrode 142 of the driving transistor 130 through a through hole formed in the planarization film 146. As a result, the potential corresponding to the video signal is supplied to the pixel electrode 152 through the signal line 144 and the driving transistor 130. Note that the display device 100 is driven by the so-called inversion-driving method. Therefore, the polarity of the potential corresponding to the video signal is inverted frame-by-frame with respect to the constant potential applied to the common electrode 154.

The pixel electrode 152 also transmits visible light in order to transmit the light from the backlight. Therefore, the pixel electrode 152 includes a light-transmitting conductive oxide such as indium-tin oxide (ITO) and indium-zinc oxide (IZO), for example. As shown in FIG. 2, the pixel electrodes 152 are provided for each pixel 120. The pixel electrodes 152 may have a bent shape along the signal lines 144 as shown in FIG. 2 or may have a rectangular shape without a bent structure, although not illustrated.

The interelectrode insulating film 162 insulates the pixel electrode 152 and the common electrode 154. The interelectrode insulating film 162 is composed as a monolayer or multilayer film containing, for example, a silicon-containing inorganic compound and an aluminum-containing inorganic compound. Note that a storage capacitance may be formed in each pixel circuit by arranging the pixel electrode 152 and a capacitance electrode (not illustrated) to face each other through the interelectrode insulating film 162.

The common electrode 154 faces the pixel electrode 152 through the interelectrode insulating film 162. Here, the common electrode 154 is provided over a plurality or all of the pixels 120. That is, the common electrode 154 is shared by a plurality or all of the pixels 120. The common electrode 154 also includes a light-transmitting conductive oxide such as ITO and IZO to transmit visible light. Furthermore, the common electrode 154 has a slit 154a overlapping the pixel electrode 152 as shown in FIG. 2, and the pixel electrode 152 and the interelectrode insulating film 162 are exposed through the slit 154a. There is no restriction on the number of slits 154a provided in each pixel 120. Therefore, there may be one or more slits 154a in each pixel 120. The longitudinal direction of the slit 154a may be orthogonal to the scanning line 136 or may be inclined from the scanning lines 136 (or the direction of the arrangement of the pixels 120 along the signal lines 144) as shown in FIG. 2. For example, the longitudinal direction of the slit 154a may be inclined at an angle equal to or more than 75° and less than 90° from the direction in which the scanning lines 136 extend. As described above, a predetermined constant potential is supplied to the common electrode 154. The potential applied to the common electrode 154 may be a ground potential (0 V) or may be a negative potential with respect to the ground potential in view of the influences of various parasitic capacitances in the pixel 120 such as the capacitance formed by the common electrode 154, the interelectrode insulating film 162, and the pixel electrode 152. For example, the potential applied to the common electrode 154 may be equal to or higher than −1.0 V and equal to or lower than −0.1 V and typically −0.5 V.

The first orientation film 156 and the second orientation film 160 are provided to control the orientation direction of the liquid crystal molecules structuring the liquid crystal layer 158, and both contain a polymer such as a polyimide and a polyester. The first orientation film 156 and the second orientation film 160 are formed using a wet deposition method such as an ink-jet method, a spin-coating method, a printing method, and a dip-coating method, and their surfaces are subjected to a rubbing process. Alternatively, the first orientation film 156 and the second orientation film 160 may be formed by a photo-alignment treatment. The first orientation film 156 and the second orientation film 160 are provided so that the directions in which the liquid crystal molecules are oriented are parallel to each other.

The spacer 164 includes a resin such as an acrylic resin and is provided between adjacent pixels 120, for example. The spacer 164 shown in FIG. 3 is fixed over the common electrode 154 and is covered by the first orientation film 156, but the thickness of the liquid crystal layer 158 may be maintained by dispersing spherical spacers in the liquid crystal layer 158, for example. In this case, the spacers are placed between the first orientation film 156 and the second orientation film 160.

### 4. OTHER COMPONENTS

The counter substrate 104 is provided with a color filter 168 absorbing a part of the light passing through the liquid crystal element 150 to give color information and a light-shielding film (black matrix) 166 shielding unnecessary light. The color filter 168 is provided in such a way that absorption characteristics are different between adjacent pixels 120. The light-shielding film 166 may be composed of a resin containing a black or similarly colored pigment and is preferably arranged to overlap the light-shielding film 122, the through hole formed in the planarization film 146, and the driving transistor 130. In order to block unnecessary light while allowing the light configured to pass through the color filter 168 to pass through the color filter 168, the light-shielding film 166 is provided to cover the space between adjacent pixels 120. Accordingly, the light-shielding film 166 is formed as a film having a plurality of openings overlapping the plurality of pixels 120 as described below.

A first light-transmitting conductive film 170 is further provided to the counter substrate 104 through the light-shielding film 166 and the color filter 168. The first light-transmitting conductive film 170 is provided to overlap the plurality of pixels 120. Thus, the display device 100 may have a single first light-transmitting conductive film 170 overlapping all of the pixels 120 or may have a plurality of first light-transmitting conductive films 170 respectively overlapping the plurality of pixels 120. In the latter case, each pixel 120 overlaps any one of the first light-transmitting conductive films 170. The first light-transmitting conductive film 170 includes a light-transmitting conductive oxide such as ITO and IZO to allow the images reproduced in the display region DR to be visible. The first light-transmitting conductive film 170 is preferably provided with a thickness of equal to or more than 10 nm and equal to or less than 100 nm, more preferably equal to or more than 10 nm and equal to or less than 50 nm, and even more preferably equal to or more than 10 nm and equal to or less than 30 nm, in order to maintain high light-transmitting properties.

The first light-transmitting conductive film 170 may be configured to be electrically floating or may be configured so as to be applied with a constant potential (e.g., ground potential). Alternatively, the first light-transmitting conductive film 170 may be configured to be supplied with the same potential as the common electrode 154.

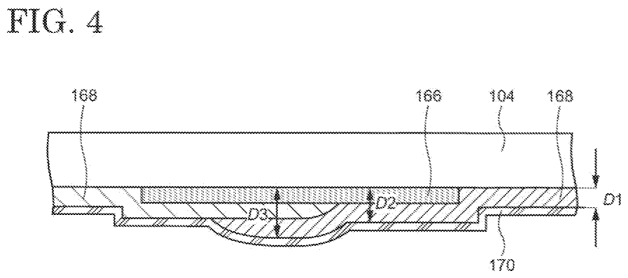

As shown in FIG. 3, the color filters 168 may have different thicknesses to obtain appropriate absorbance because of the different absorption characteristics between adjacent pixels 120. In addition, when there is an overlap between adjacent pixels 120, the thickness may increase in the overlapping portion. Therefore, the top surfaces of the plurality of color filters 168 (the bottom surfaces in FIG. 3 and the surfaces of the color filters 168 opposite to the counter substrate 104) may not be necessarily flat and may have irregularities. Therefore, the distance D from the first light-transmitting conductive film 170 formed to be in contact with the color filters 168 to the counter substrate 104 (the distance from the top surface of the first light-transmitting conductive film 170 to the bottom surface of the counter substrate 104) may be the same or different between adjacent pixels 120. Alternatively, the distance D may be the same or different between adjacent color filters 168. That is, the distance D varies from place to place depending on the thickness of the color filter 168 in each pixel 120, the stacking state of the color filters 168, and the stacking state including the light-shielding film 166. To elaborate on this point using FIG. 4, assuming that D₁ is a distance at a position where there is only one color filter 168 between the first light-transmitting conductive film 170 and the counter substrate 104, D₂ is a distance at a position where this color filter 168 and the light-shielding film 166 are stacked, and D₃ is a distance at a position where the color filters 168 are stacked and the light-shielding film 166 is further stacked, then a relationship of D₁<D₂<D₃ is obtained.

As shown in FIG. 3, the counter substrate 104 is further provided with an overcoat 172 covering the first light-transmitting conductive film 170. Thus, the first light-transmitting conductive film 170 is sandwiched between the light-shielding film 166 and the overcoat 172 and between the color filters 168 and the overcoat 172. The overcoat 172 is provided to be shared by the plurality of pixels 120. The overcoat 172 may also be composed of one or a plurality of films containing a silicon-containing inorganic compound or may be formed to contain a polymer such as an acrylic resin, an epoxy resin, a polyimide, and a polyamide. It is possible to suppress impurities contained in the counter substrate 104, the color filter 168, the light-shielding film 166, and the like from penetrating to the liquid crystal element 150 by providing the overcoat 172. Particularly, the unevenness caused by the color filters 168 and the light-shielding film 166 can be mitigated and the flatness of their upper surfaces (the lower surface in FIG. 3 and the surface of the overcoat 172 opposite to the counter substrate 104) can be improved by providing the overcoat 172 containing a polymer. As a result, the flat second orientation film 160 can be formed over the overcoat 172. Thus, the thickness T of the overcoat 172 may be the same between adjacent pixels 120 or may be different between adjacent pixels 120 when the thicknesses of the color filters 168 are different.

The display device 100 may have, as an optional component, an auxiliary wiring 148 electrically connected to the common electrode 154. The auxiliary wiring 148 is provided in order to prevent a voltage drop in the common electrode 154 and is formed, for example, as a single-layer or multilayer film containing a metal such as aluminum, titanium, tungsten, molybdenum, copper, nickel, and tantalum or an alloy thereof. In the example shown in FIG. 3, the auxiliary wiring 148 is provided below the common electrode 154, but the auxiliary wiring 148 may be placed over the common electrode 154. Although there is no restriction on the position where the auxiliary wiring 148 is provided, the auxiliary wiring 148 is preferably arranged so as to overlap the light-shielding film 122, the through hole formed in the planarization film 146, or the driving transistor 130 and to be parallel to the scanning lines 136 and signal lines 144 in order not to block the light whose graduation is controlled by the liquid crystal layer 158 as shown in FIG. 3.

Moreover, the display device 100 may have, as an optional component, a second light-transmitting conductive film 176 as an antistatic film over the counter substrate 104. The second light-transmitting conductive film 176 also includes a light-transmitting conductive oxide such as ITO and IZO. A constant potential (e.g., ground potential) is applied to the second light-transmitting conductive film 176. The formation of the second light-transmitting conductive film 176 allows the external electric field to be shielded and prevents the liquid crystal element 150 from being affected by the electric field. However, when the first light-transmitting conductive film 170 is able to sufficiently shield the external electric field, the second light-transmitting conductive film 176 may not be provided.

### 5. STRUCTURE OF FRAME REGION

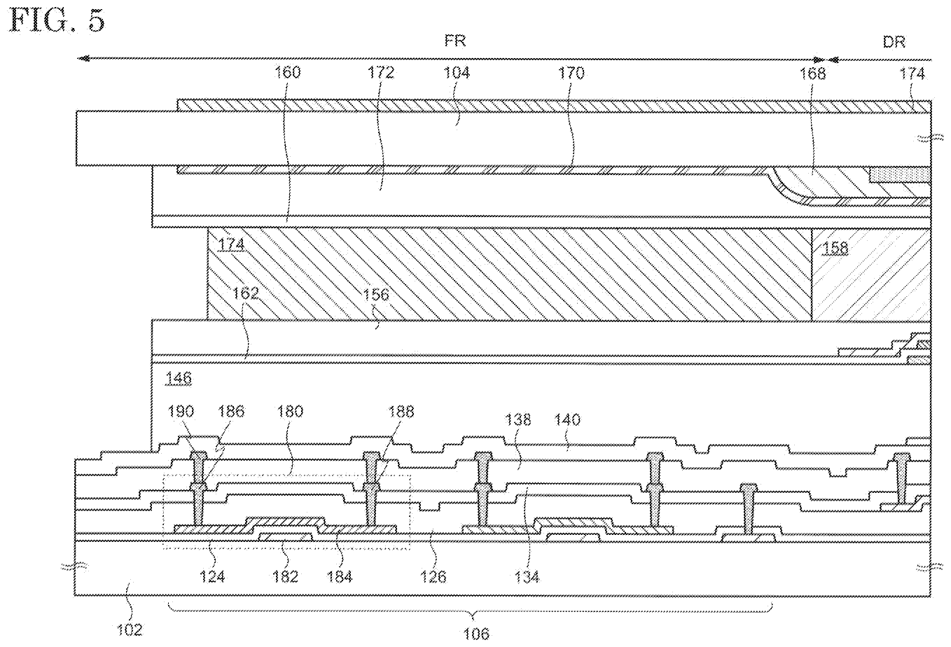

As described above, the scanning line driver circuits 106 are provided in the frame region FR. A schematic view of a cross section of the frame region FR is shown in FIG. 5. As shown in FIG. 5, the array substrate 102 and the counter substrate 104 are fixed to each other by the sealing material 174 provided in the frame region FR, and the liquid crystal layer 158 is sealed in the space formed by the array substrate 102, the counter substrate 104, and the sealing material 174.

The scanning line driver circuits 106 are configured by appropriately connecting a plurality of circuit transistors 180 and capacitance elements which are not illustrated. The configuration of the circuit transistors 180 may also be determined arbitrarily. For example, the circuit transistor 180 is composed of a gate electrode 182, a semiconductor film 184 overlapping the gate electrode 182, a gate insulating film 124 between the gate electrode 182 and the semiconductor film 184, a first interlayer insulating film 126 covering the gate electrode 182 and the semiconductor film 184, a pair of terminals 186 and 188 electrically connected to the semiconductor film 184 via through holes provided in the first interlayer insulating film 126 and the gate insulating film 134, and the like as shown in FIG. 5. The pair of terminals 186 and 188 may be electrically connected to the wirings 190 in through holes provided in the second interlayer insulating film 138. The semiconductor film 184 of the circuit transistor 180 may be configured to include silicon, which allows the formation of the scanning line driver circuits 106 capable of being driven at high speed. The gate insulating film 124 and the first interlayer insulating film 126 may be composed of the silicon-containing inorganic compound or the aluminum-containing inorganic compound described above. The gate electrode 182, the pair of terminals 186 and 188, and the wirings 190 may also be formed to include a metal such as aluminum, titanium, tungsten, molybdenum, copper, nickel, and tantalum or an alloy thereof.

As described above, the display device 100 is an FFS-type transmissive liquid crystal display, and the gradation of light emitted from the backlight and then passing through the liquid crystal layer is controlled pixel-by-pixel by controlling the orientation of the liquid crystal layer 158 pixel-by-pixel. Therefore, the first orientation film 156, the second orientation film 160, the color filter 168, and the light-shielding film 166 are always exposed to the light from the backlight when the display device 100 is driven, resulting in the generation of holes and electrons in these films by photoexcitation. When the driving transistor 130 is turned on in this state, electrons are injected from the common electrode 154 into the first orientation film 156 because the first orientation film is in contact with the common electrode 154. As a result, the holes partly disappear in the first orientation film 156 due to recombination, and the charge balance is disrupted in the first orientation film 156, resulting in an electron-rich state.

Thereafter, the driving transistor 130 is turned off after a predetermined period of time. Here, in the case where the off current of the driving transistor is large, for example, the charge balance in the first orientation film 156 is rapidly recovered because a part of the charge is transferred through the pixel electrode 152 and semiconductor film 132 even in the off state. However, the off current of the driving transistor 130, which includes an oxide semiconductor in the semiconductor film 132 as described in the present embodiment, is extremely low and negligible. Therefore, recovery of the charge balance in the first orientation film 156 is slow, and the charge-unbalanced state is maintained. If such a phenomenon occurs, the charge bias accumulates every time the driving transistor 130 is turned on, which is considered to aggravate the polarization of the other layers. For example, it is considered that the charge bias even affects the polarization of the light-shielding film 166 on the counter substrate 104 side and that the polarization of the light-shielding film 166 further promotes a potential shift (Vcom shift) of the common electrode 154 on the array substrate 102 side. This phenomenon tends to be particularly remarkable when the light-shielding film 166 with a high dielectric constant is provided. Since such a Vcom shift may cause flicker generation, the display quality degrades.

However, in the display device 100 according to an embodiment of the present invention, the first light-transmitting conductive film 170 having conductivity is placed between the color filters 168 and the overcoat 172 and between the light-shielding film 166 and the overcoat 172. Therefore, even if the charge imbalance is disrupted in the first orientation film 156, the electric field generated by the imbalance is shielded by the first light-transmitting conductive film 170, thereby preventing the polarization of the color filters 168 and light-shielding film 166. As a result, the Vcom shift is prevented, and flicker caused by the Vcom shift is suppressed. Therefore, implementation of an embodiment of the present invention allows the production of a liquid crystal display device with high display quality.

### 6. MODIFIED EXAMPLES

The configuration of the display device 100 is not limited to those described above, and a variety of modifications is feasible. Hereinafter, modified examples are described.

### (1) Modified Example 1

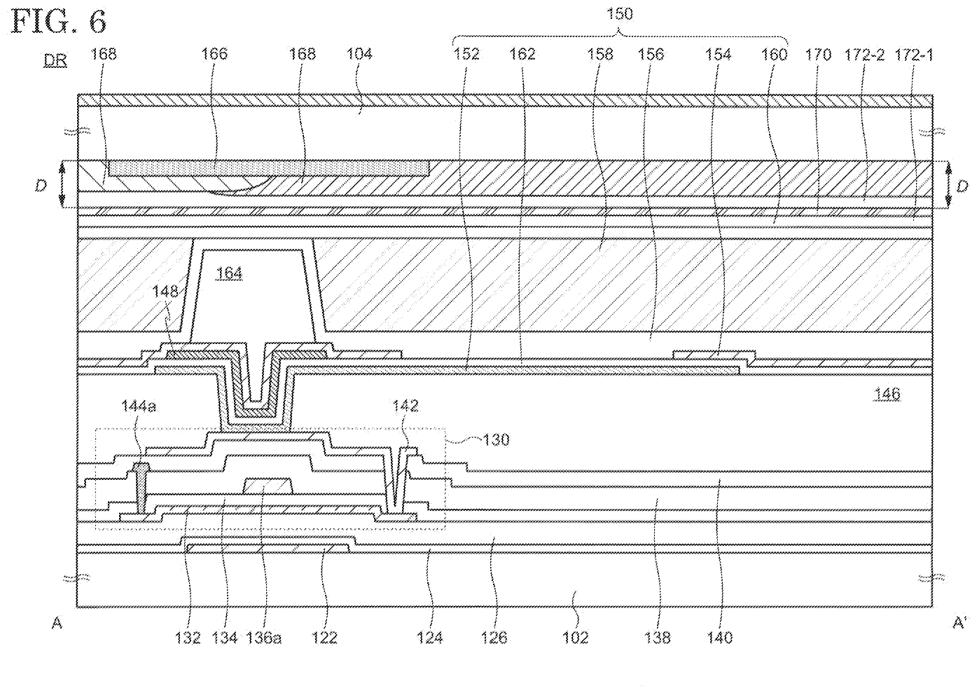

As shown in FIG. 6, two overcoats 172-1 and 172-2 may may be arranged to overlap each other, and the first light-transmitting conductive film 170 may be placed therebetween. The thicknesses of the overcoats 172-1 and 172-2 may be the same as or different from each other. In addition, the compositions of the overcoats 172-1 and 172-2 may be the same as or different from each other. When the overcoat 172-1 on the color filter 168 side contains a polymer, the distance D may be the same or substantially the same between adjacent pixels 120 because the unevenness caused by the color filters 168 and the light-shielding film 166 can be relatively readily absorbed in the Modified Example 1.

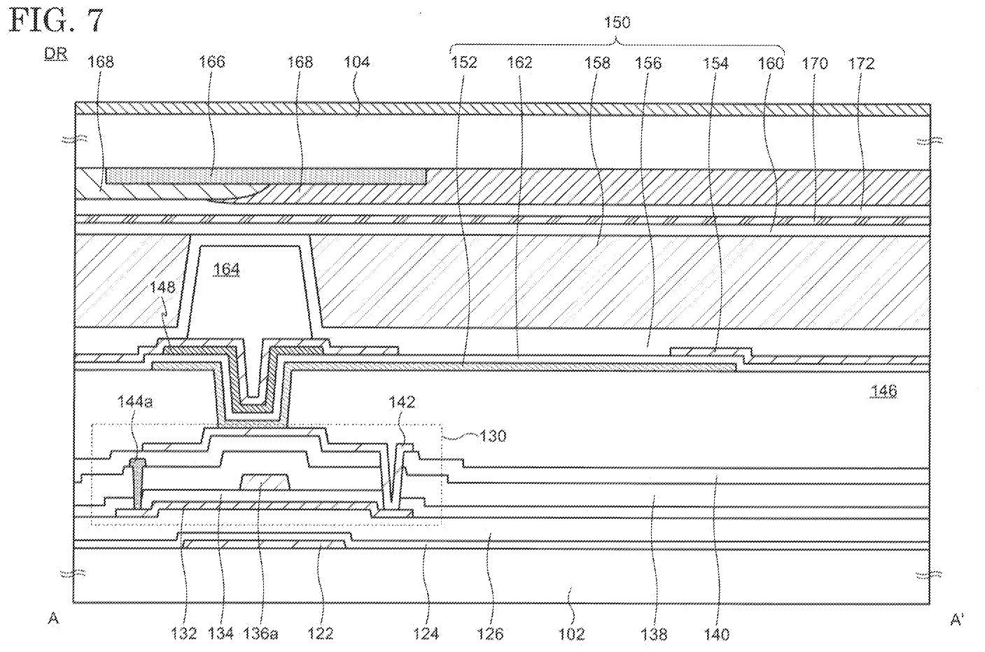

Alternatively, the first light-transmitting conductive film 170 may be arranged between the second orientation film 160 and the overcoat 172 as shown in FIG. 7. In this case, the use of the overcoat 172 including a polymer also allows the distance D to be the same or substantially the same between adjacent pixels 120.

In the Modified Example 1, the polarization of the color filter 168 and the light-shielding films 166 can also be prevented because, even in the case where the charge balance in the first orientation film 156 is disrupted, the electric field generated by the imbalance can be shielded by the first light-transmitting conductive film 170. Therefore, even if the charge balance of the first orientation film 156 is disrupted due to the extremely low off-current of the driving transistor 130, Vcom shift can be effectively prevented.

### (2) Modified Example 2

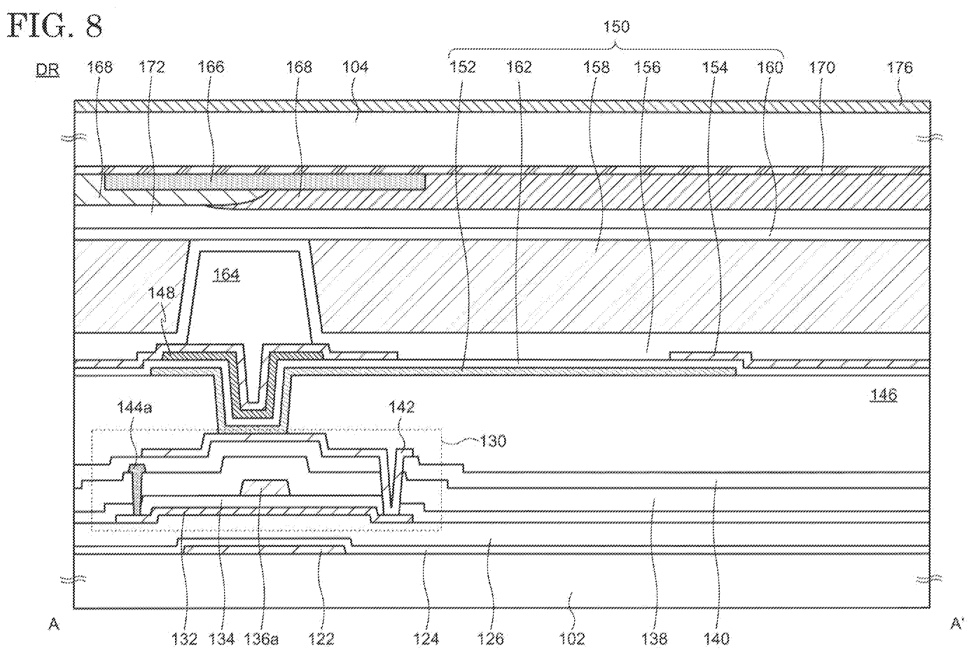

Alternatively, the first light-transmitting conductive film 170 in contact with the light-shielding film 166 may be arranged between the counter substrate 104 and the light-shielding film 166 as shown in FIG. 8. In this case, the polarization in the light-shielding film 166 can be prevented even when the charge balance is disrupted in the first orientation film 156 because the charge transfer is possible between the first light-transmitting conductive film 170 and the light-shielding film 166. As a result, flicker generation is suppressed, and high-quality images can be provided.

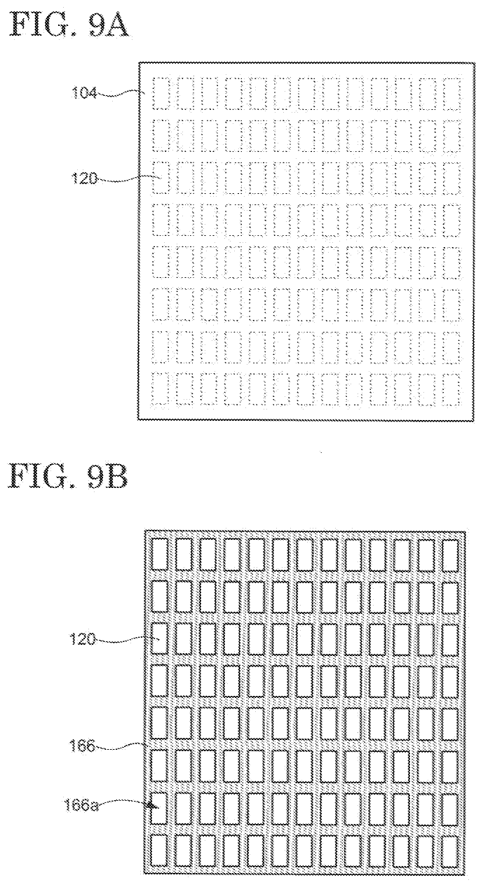

In the Modified Example 2, the display device 100 does not necessarily need to have a single first light-transmitting conductive film 170 overlapping all of the pixels 120 but may have the first light-transmitting conductive film 170 having various shape patterns as explained using FIG. 9A to FIG. 12. FIG. 8 to FIG. 12 are schematic top views (plan views) of the display device 100. In FIG. 9B to FIG. 12, the counter substrate 104 is not illustrated, and the arrangement relationship between the pixel 120, the light-shielding film 166, and the first light-transmitting conductive film 170 is demonstrated.

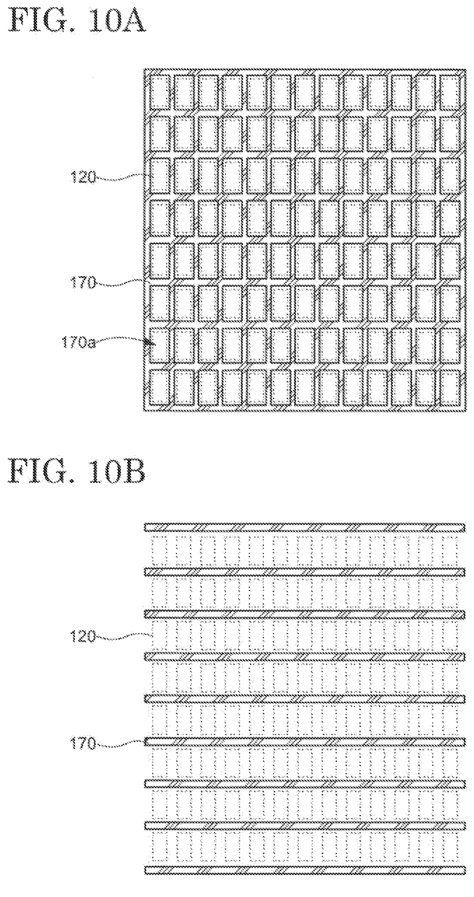

For example, when the pixels 120 are arranged in a matrix shape under the counter substrate 104 as shown in FIG. 9A, the light-shielding film 166 is arranged to cover the regions between adjacent pixels 120 (FIG. 9B). That is, the light-shielding film 166 has a plurality of openings 166a arranged in a matrix shape and facing the pixels 120. At this time, the first light-transmitting conductive film 170 may also be configured to have a plurality of openings 170a arranged in a matrix shape and facing the pixels 120 (FIG. 10A). Hence, the first light-transmitting conductive film 170 may be formed as a single film exposing at least a portion of the pixels 120 and overlapping the light-shielding film 166.

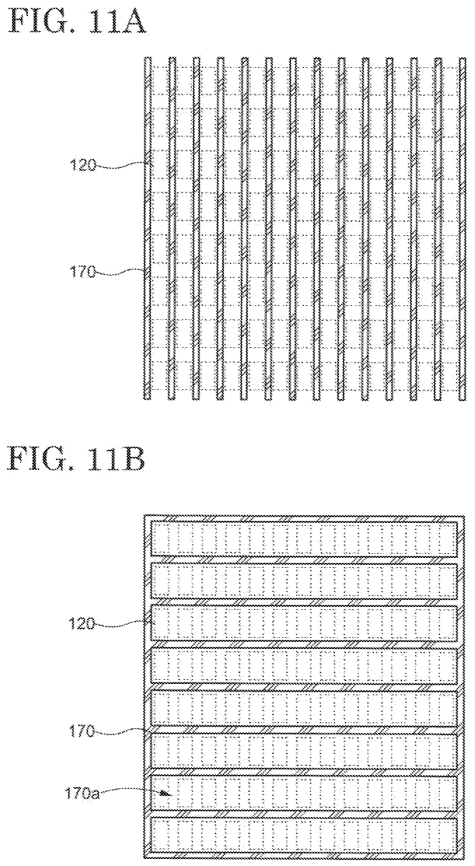

Alternatively, the display device 100 may have a plurality of first light-transmitting conductive films 170 arranged in a stripe shape parallel to one another as shown in FIG. 10B and FIG. 11A. In this case, the longitudinal direction of the plurality of first light-transmitting conductive films 170 is the direction in which the scanning lines 136 or the signal lines 144 extend or the direction in which the pixels 120 extend along the scanning lines 136 or the signal lines 144. Moreover, each first light-transmitting conductive film 170 extends so as to overlap the light-shielding film 166.

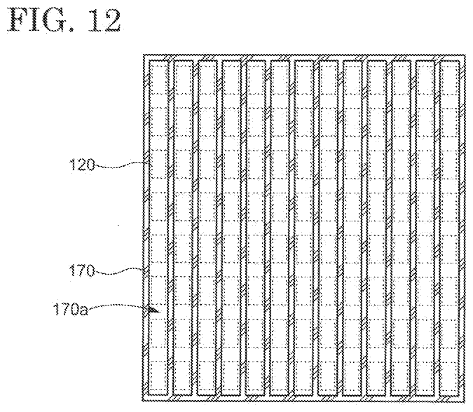

Alternatively, the display device 100 may have the first light-transmitting conductive film 170 having a plurality of openings 170a as shown in FIG. 11B and FIG. 12. The longitudinal direction of the plurality of openings 170a is the direction in which the scanning lines 136 or the signal lines 144 extend or the direction in which the pixels 120 extend along the scanning lines 136 or the signal lines 144. Each opening 170a overlaps the plurality of pixels 120 arranged in the direction in which the scanning lines 136 or the signal lines 144 extend. In this case, the first light-transmitting conductive film 170 is also arranged to overlap the light-shielding film 166.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A display device comprising:
a substrate;
a plurality of pixels located over the substrate and each including a liquid crystal element;
a first overcoat over the plurality of pixels;
a first light-transmitting conductive film over the first overcoat; and
a plurality of color filters over the first light-transmitting conductive film.

2. The display device according to claim 1,
wherein each of the plurality of pixels comprises a pixel circuit including a driving transistor electrically connected to the liquid crystal element, and
the driving transistor includes an oxide semiconductor.

3. The display device according to claim 1,
wherein the first light-transmitting conductive film is electrically floated.

4. The display device according to claim 1,
wherein the first light-transmitting conductive film is configured to be applied with a ground potential.

5. The display device according to claim 1,
wherein the liquid crystal element comprises:
a pixel electrode;
an interelectrode insulating film over the pixel electrode;
a common electrode over the interelectrode insulating film;
a first orientation film over the common electrode;
a liquid crystal layer over the first orientation film; and
a second orientation film over the liquid crystal layer, and
the first light-transmitting conductive film is configured to be applied with a potential the same as a potential applied to the common electrode.

6. The display device according to claim 1, further comprising a counter substrate opposing the substrate,
wherein the substrate has a first region and a second region,
the plurality of pixels includes a first pixel and a second pixel adjacent to the first pixel,
the first pixel is located over the first region,
the second pixel is located over the second region, and
a distance from the counter substrate to the light-transmitting conductive film is different between the first region and the second region.

7. The display device according to claim 1, further comprising a light-shielding film over the plurality of color filters.

8. The display device according to claim 1, further comprising a second overcoat between the first light-transmitting conductive film and the plurality of color filters.

9. The display device according to claim 1, further comprising:
a counter substrate opposing the substrate; and
a second light-transmitting conductive film over the counter substrate.

10. A display device comprising:
a substrate;
a plurality of pixels located over the substrate and each including a liquid crystal element;
an overcoat over the plurality of pixels;
a plurality of color filters located over the overcoat and respectively overlapping the corresponding pixels;
a light-shielding film located over the plurality of color filters and extending between two adjacent pixels among the plurality of pixels; and
at least one light-transmitting conductive film over and in contact with the light-shielding film.

11. The display device according to claim 10,
wherein each of the plurality of pixels comprises a pixel circuit including a driving transistor electrically connected to the liquid crystal element, and
the driving transistor includes an oxide semiconductor.

12. The display device according to claim 10,
wherein the at least one first light-transmitting conductive film is electrically floated.

13. The display device according to claim 10,
wherein the at least one first light-transmitting conductive film is configured to be applied with a ground potential.

14. The display device according to claim 10,
wherein the liquid crystal element comprises:
a pixel electrode;
an interelectrode insulating film over the pixel electrode;
a common electrode over the interelectrode insulating film;
a first orientation film over the common electrode;
a liquid crystal layer over the first orientation film; and
a second orientation film over the liquid crystal layer, and
the at least one first light-transmitting conductive film is configured to be applied with a potential the same as a potential applied to the common electrode.

15. The display device according to claim 10,
wherein the at least one first light-transmitting conductive film overlaps the plurality of pixels.

16. The display device according to claim 10,
wherein the at least one first light-transmitting conductive film has a plurality of openings respectively overlapping the corresponding pixels.

17. The display device according to claim 10,
wherein the at least one first light-transmitting conductive film includes a plurality of first light-transmitting conductive films arranged in a stripe shape, and
the plurality of first light-transmitting conductive films extends so as to overlap the light-shielding film.

18. The display device according to claim 10, further comprising:
a counter substrate opposing the substrate; and
a second light-transmitting conductive film over the counter substrate.
